(19) United States
(12) Patent Application Publication
(10) Pub. No.: US 2020/0011891 A1
(43) Pub. Date: Jan. 9, 2020

(54) SAMPLE INJECTION PROPULSION MECHANISM FOR BIOCHEMICAL ANALYZER

(71) Applicant: NINGBO MEDICAL SYSTEM BIOTECHNOLOGY CO., LTD., NINGBO (CN)

(72) Inventors: Jihua ZOU, NINGBO (SG); Tao XIONG, NINGBO (CN); Xiaohui WU, NINGBO (CN); Shangqing XIAO, NINGBO (CN); Lei XU, NINGBO (CN); Zhe FENG, NINGBO (CN)

(21) Appl. No.: 16/446,425

(22) Filed: Jun. 19, 2019

Related U.S. Application Data
(63) Continuation of application No. PCT/CN2017/108515, filed on Oct. 31, 2017.

(30) Foreign Application Priority Data
Dec. 19, 2016 (CN) 201611174912.6

(51) Int. Cl. G01N 35/10

(52) U.S. Cl. CPC G01N 35/1083

(57) ABSTRACT

A sample feeding propulsion mechanism for biochemical analyzer, comprising a push plate (1), a horizontal guide rail (2), a motor (3), and it further comprises a propulsive guide plate (4), a thrust roller (5) and a rotating wheel (6), the propulsive guide plate (4) is in sliding fit on the horizontal guide rail (2), the push plate (1) is joined to the propulsive guide plate (4); the rotating wheel 6 is mounted on an output shaft of the motor; the thrust roller is eccentrically mounted on one side of the rotating wheel, the propulsive guide plate is provided with a guide groove forming an included angle with the horizontal guide rail in their length directions; and the thrust roller is in rolling fit in the guide groove. The sample feeding propulsion mechanism for biochemical analyzer in this disclosure is simple in structure, small in size and occupied mounting space.

### CROSS-REFERENCE TO RELATED APPLICATIONS

This application is a continuation of International Patent Application No. PCT/CN2017/108515 with a filing date of Oct. 31, 2017, designating the United States, now pending, and further claims priority to Chinese Patent Application No. 201611174912.6 with a filing date of Dec. 19, 2016. The content of the aforementioned application, including any intervening amendments thereto, is incorporated herein by reference.

### TECHNICAL FIELD

The present disclosure relates to the technical field of medical equipment, in particular to a sample feeding propulsion mechanism for biochemical analyzer.

### BACKGROUND

With the rapid development of the modern technology, automation equipment has been widely used in the biomedical testing industry on the grounds that it can substitute for a majority of tedious manual operation with the obvious advantages of accurate result, small error, biochemical pollution prevention, high testing speed and high efficiency. However, there remain many unsatisfactory issues in the existing medical testing equipment, e.g., the current sample feeding propulsion mechanism for biochemical analyzer is operable via a stepping motor and a synchronous belt, that is, a sample feeding propulsion plate is in sliding fit on a linear guide rail, and driven by the synchronous belt to push in a reciprocating manner. The above sample feeding propulsion mode is simple in structure, but occupies more mounting space due to its large size.

### SUMMARY

The technical problem to be solved by the present disclosure is to provide a sample feeding propulsion mechanism for biochemical analyzer which is simple in structure, small in size and occupied mounting space.

The technical solution of the present disclosure provides a sample feeding propulsion mechanism for biochemical analyzer structurally comprising a push plate, horizontal guide rails and a motor, and further comprising a propulsive guide plate, a thrust roller and a rotating wheel, the propulsive guide plate is in sliding fit on the horizontal guide rails; the push plate is joined to the propulsive guide plate; the rotating wheel is mounted on an output shaft of the motor; the thrust roller is eccentrically mounted on one side of the rotating wheel; the propulsive guide plate is provided with a guide groove forming an included angle with the horizontal guide rails in their length directions, and the thrust roller is in rolling fit in the guide groove.

By adopting the abovementioned structure, the sample feeding propulsion mechanism for biochemical analyzer of the present disclosure has the following advantages as compared with the prior art:

As the sample feeding propulsion mechanism for biochemical analyzer comprises the propulsive guide plate, the thrust roller and the rotating wheel, the propulsive guide plate is in sliding fit on the horizontal guide rails, the motor drives the rotating wheel to rotate, the thrust roller is eccentrically mounted on and driven by the rotating wheel to do eccentric motion so as to slide in the guide groove. Besides, an include angle is formed between the guide groove and the horizontal guide rails in their length directions, in such a case, the propulsive guide plate slides back and forth along the horizontal guide rails under the drive of the thrust roller. Such the mode produces the effects of simple structure, small size and occupied mounting space.

As an improvement, the include angle formed between the guide groove and the horizontal guide rails in their length directions is 90°. The design adopting the above structure is the optimal embodiment.

As an improvement, the sample feeding propulsion mechanism further comprises a base plate. The horizontal guide rails and the motor are separately mounted on the upper and lower sides of the base plate. The rotating wheel is arranged above the base plate; and the output shaft of the motor penetrates through the base plate to be joined to the rotating wheel. The design adopting the above structure is more compact in structure and less in occupied space.

As an improvement, the sample feeding propulsion mechanism also comprises a lifting structure that includes a lifting guide plate at one side of the push plate. One side proximal the push plate of the lifting guide plate is provided with an annular lifting guide groove. One side of the push plate is provided with a guide roller in rolling fit in the lifting guide groove. The push plate is joined to the propulsive guide plate in a vertically movable manner. Such the structure enables the push plate to move up and down under the drive of the lifting structure, so that the push plate may avoid a sample being delivered within a track during the resetting process, thereby improving delivery efficiency.

As an improvement, an upper elastic sheet pressing the guide roller downward is mounted on one end of the upper side of the lifting guide groove, while a lower elastic sheet pushing the guide roller upward is mounted on the other end of the lower side of the lifting guide groove. Such the structure makes the push plate lift more smoothly.

As an improvement, there are vertical guide rails on the propulsive guide plate The push plate is in sliding fit on the vertical guide rails. Due to the structure, the push plate is enabled to lift more steadily, and structure becomes more reliable.

As an improvement, the vertical guide rails are secured on the propulsive guide plate via a mounting plate. The push plate is connected with a fixing plate on which a first slider in sliding fit on the vertical guide rails is mounted There is a tension spring between the mounting plate and the fixing plate, with its upper end joined to the mounting plate, and lower end joined to the fixing plate. By adopting the structure, assisted by the tension spring, the guide roller is enabled to roll more smoothly in the guide groove. The fixing plate also has a support at one side. The guide roller is joined to the support. The lower end of the tension spring is joined to the support. By adopting the above structure, structure design is more reasonable.

As an improvement, a transmission-type optical interrupter with an interrupt slot is mounted on one end of the upper side of the base plate. The push plate also has a baffle for blocking light rays in the interrupt slot after penetrating therethrough. By adopting the above structure, the transmission-type optical interrupter can monitor the movement state of the push plate and transmits a signal to a controller.

### BRIEF DESCRIPTION OF THE DRAWINGS

FIG. 1 is a schematic diagram of a stereo structure of a sample feeding propulsion mechanism for biochemical analyzer of the present disclosure.

FIG. 2 is a partially schematic structural diagram of the sample feeding propulsion mechanism for biochemical analyzer of the present disclosure.

FIG. 3 is a partially schematic structural diagram of the sample feeding propulsion mechanism for biochemical analyzer of the present disclosure

FIG. 4 is a schematic structural diagram of a rotating wheel of the sample feeding propulsion mechanism for biochemical analyzer of the present disclosure.

FIG. 5 is a schematic structural diagram of a propulsive guide plate of the sample feeding propulsion mechanism for biochemical analyzer of the present disclosure.

FIG. 6 is a schematic structural diagram of a mounting plate of the sample feeding propulsion mechanism for biochemical analyzer of the present disclosure.

FIG. 7 is a schematic structural diagram of a lifting guide plate of the sample feeding propulsion mechanism for biochemical analyzer of the present disclosure.

The reference numerals denote: 1 push plate; 2 horizontal guide rail; 3 motor; 4 propulsive guide plate; 4.1 guide groove; 5 thrust roller; 6 rotating wheel; 7 base plate; 8 second slider; 9 lifting guide plate; 10 lifting guide groove; 11 guide roller; 12 upper elastic sheet; 13 lower elastic sheet; 14 vertical guide rail; 15 mounting plate; 16 fixing plate; 17 first slider; 18 tension spring; 19 support; 20 transmission-type optical interrupter; 21 baffle.

### DETAILED DESCRIPTION OF THE EMBODIMENTS

The disclosure will be further explained below in detail in combination with the drawings and embodiments.

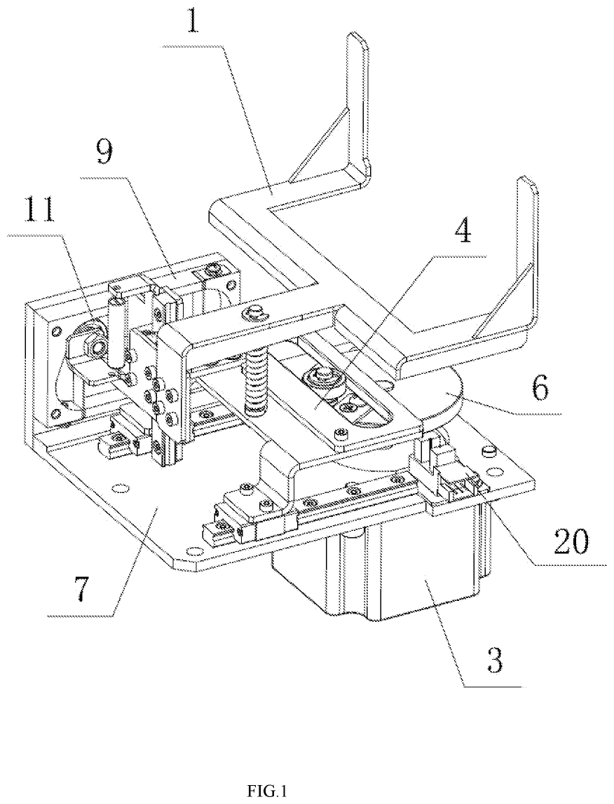

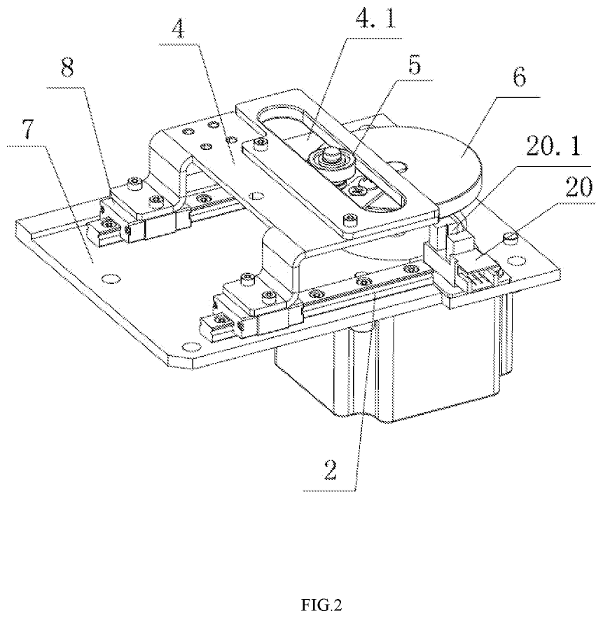

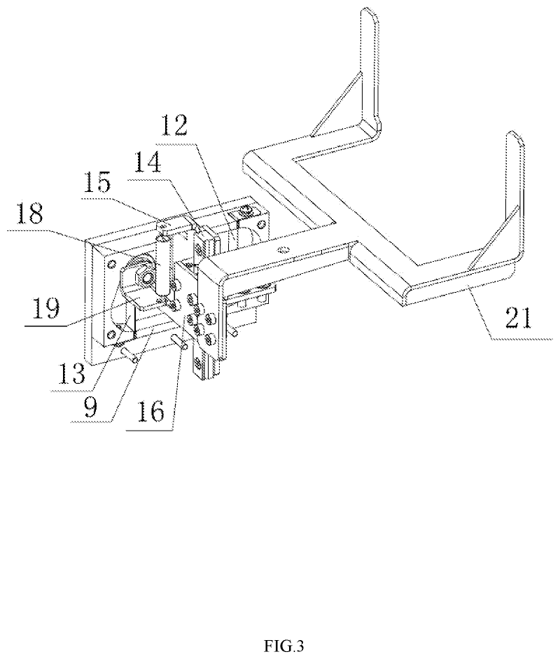

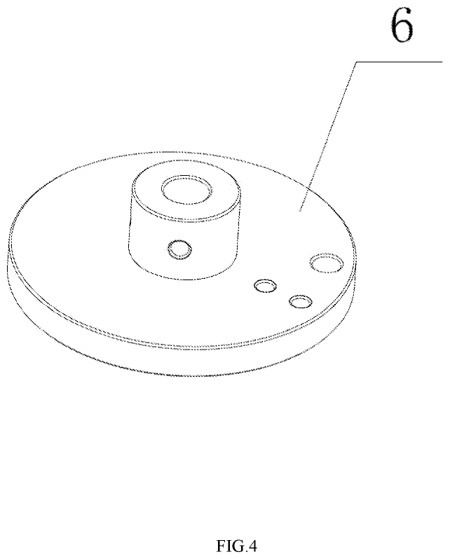

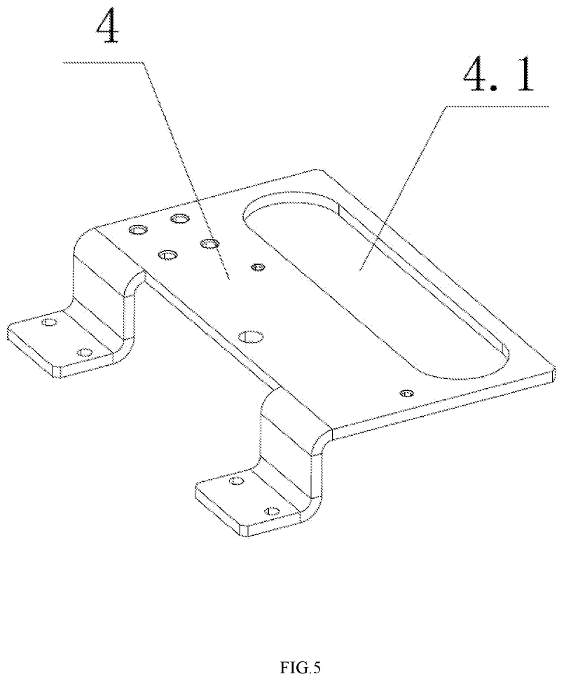

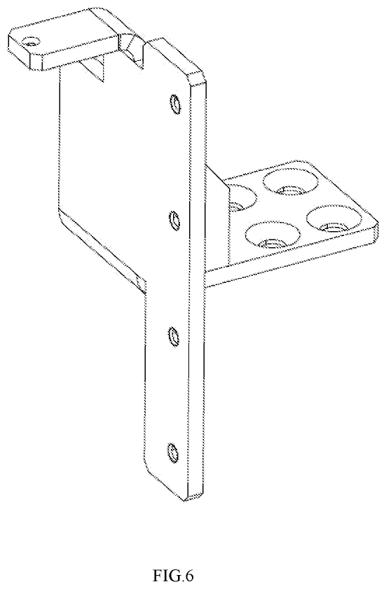

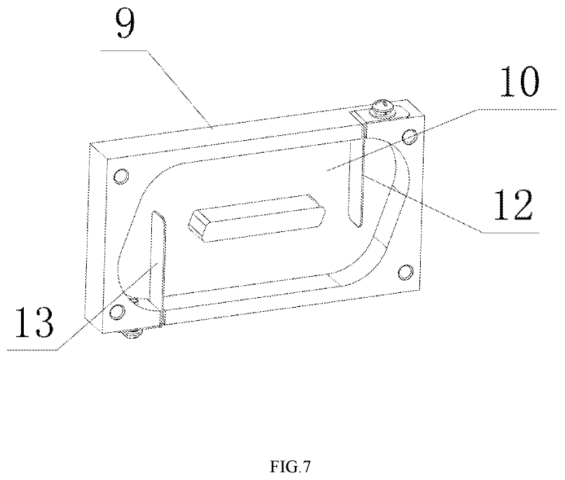

Referring to FIGS. 1-7, the sample feeding propulsion mechanism for biochemical analyzer comprises a push plate 1, horizontal guide rails 2, a motor 3, a propulsive guide plate 4, a thrust roller 5 and a rotating wheel 6, the propulsive guide plate 4 is in sliding fit on the horizontal guide rails 2, the push plate 1 is joined to the propulsive guide plate 4; the rotating wheel 6 is mounted on an output shaft of the motor 3; the thrust roller 5 is eccentrically mounted on one side of the rotating wheel 6, the propulsive guide plate 4 is provided with a guide groove 4.1 forming an included angle with the horizontal guide rails 2 in their length directions; and the thrust roller 5 is in rolling fit in the guide groove 4.1. In this embodiment, an include angle of 90° is formed between the guide groove 4.1 and the horizontal guide rails 2 in their length directions.

The sample feeding propulsion mechanism further comprises a base plate 7. Two horizontal guide rails 2 are mounted on the upper, side of the base plate 7 parallel to each other. Two sides of the propulsive guide plate 4 are respectively provided with a second slider 8. The sliders 8 are in sliding fit on the horizontal guide rails 2 in a one-to-one correspondence manner. The motor 3 is mounted on the lower side of the base plate 7. The rotating wheel 6 is arranged above the base plate 7; and the output shaft of the motor 3 penetrates through the base plate 7 to be joined to the rotating wheel 6.

The sample feeding propulsion mechanism also comprises a lifting structure that includes a lifting guide plate 9 at one side of the push plate 1. The lower side of the lifting guide plate 9 is secured on the base plate 7. One side proximal the push plate 1 of the lifting guide plate 9 is provided with an annular lifting guide groove 10. One side of the push plate 1 is provided with a guide roller 11 in rolling fit in the lifting guide groove 10. The push plate 1 is joined to the propulsive guide plate 4 in a vertically movable manner.

One end at the upper side of the lifting guide groove 10 is provided with an upper elastic sheet 12 pressing the guide roller 11 downward, i.e., the upper elastic sheet 12 is contained in the lifting guide groove 10, but with its lower end suspended in the air. Space is reserved between the upper elastic sheet 12 and the side wall of one end of the lifting guide groove 10. The other end at the lower side of the lifting guide groove 10 is provided with a lower elastic sheet 13 pushing the guide roller 11 upward, i.e., the lower elastic sheet 13 is contained in the lifting guide groove 10, but with its upper end suspended in the air. Space is also reserved between the lower elastic sheet 13 and the side wall of the other end of the lifting guide groove 10.

The propulsive guide plate 4 is provided with vertical guide rails 14 where the push plate 1 is in sliding fit. The vertical guide rails 14 are secured on the propulsive guide plate 4 through a mounting plate 15. The push plate 1 is connected with a fixing plate 16 on which first sliders 17 are fixed. The first sliders 17 are in sliding fit on the vertical guide rails 14. A tension spring 18 is arranged between the mounting plate 15 and the fixing plate 16. The upper and lower ends of the tension spring 18 are respectively connected with the mounting plate 15 and the fixing plate 16. One side of the fixing plate 16 is also provided with a support 19 on which the guide roller 11 is connected. The lower end of the tension spring 18 is connected to the support 19.

One end at the upper side of the base plate 7 is provided with a transmission-type optical interrupter 20 with an interrupt slot 20.1 thereon. The push plate 1 has a baffle 21 for penetrating through the interrupt slot 20.1 to block light rays therein. In this embodiment, when the push plate 1 resets and just descends to the lowest position, the baffle 21 is contained in the interrupt slot 20.1 of the transmission-type optical interrupter 20.

The sample feeding propulsion mechanism for biochemical analyzer operates as the working principle below: a stepping motor drives the thrust roller to do eccentric rotation motion, and Y-direction linear motion in the guide groove of the propulsive guide plate. The propulsive guide plate is propelled to slide on the horizontal guide rails to complete X-direction linear motion, thereby further promoting the push plate to do X-direction linear motion.

Driven by the push plate, the guide roller does X-direction linear motion in the lifting guide groove and completes sample pushing until moving to the upper elastic sheet, at this time, the upper elastic sheet produces a downward pressure to the guide roller so as to force the push plate connected with the first sliders to move downward along the vertical guide rails. At this moment, the propulsive guide plate properly reaches its maximum stroke in the X direction and the push plate begins to return. In the returning process, under the joint effect of the lower elastic sheet and the tension spring, the push plate is forced to move upward along the vertical guide rails so as to prepare for pushing of next sample.

We claim:

1. A sample feeding propulsion mechanism for biochemical analyzer, comprising:
a push plate (1), a horizontal guide rail (2), a motor (3), wherein it further comprises a propulsive guide plate (4), a thrust roller (5) and a rotating wheel (6); the propulsive guide plate (4) is in sliding fit on the horizontal guide rail (2), the push plate (1) is joined to the propulsive guide plate (4); the rotating wheel 6 is mounted on an output shaft of the motor (3); the thrust roller (5) is eccentrically mounted on one side of the rotating wheel (6), the propulsive guide plate (4) is provided with a guide groove (4.1) forming an included angle with the horizontal guide rail (2) in their length directions; and the thrust roller (5) is in rolling fit in the guide groove (4.1).

2. The sample feeding propulsion mechanism for biochemical analyzer of claim 1, wherein an include angle of 90° is formed between the guide groove (4.1) and the horizontal guide rails (2) in their length directions

3. The sample feeding propulsion mechanism for biochemical analyzer of claim 1, wherein the sample feeding propulsion mechanism further comprises a base plate (7); the horizontal guide rail (2) is mounted on the upper side of the base plate (7); the motor (3) is mounted on the lower side of the base plate (7). The rotating wheel (6) is arranged above the base plate (7), and the output shaft of the motor (3) penetrates through the base plate (7) to be joined to the rotating wheel (6).

4. The sample feeding propulsion mechanism for biochemical analyzer of claim 1, wherein the sample feeding propulsion mechanism also comprises a lifting structure that includes a lifting guide plate (9) at one side of the push plate (1), one side proximal the push plate (1) of the lifting guide plate (9) is provided with an annular lifting guide groove (10); one side of the push plate (1) is provided with a guide roller (11) in rolling fit in the lifting guide groove (10); the push plate (1) is joined to the propulsive guide plate (4) in a vertically movable manner.

5. The sample feeding propulsion mechanism for biochemical analyzer of claim 4, wherein one end at the upper side of the lifting guide groove (10) is provided with an upper elastic sheet (12) pressing the guide roller (11) downward; the other end at the lower side of the lifting guide groove (10) is provided with a lower elastic sheet (13) pushing the guide roller (11) upward.

6. The sample feeding propulsion mechanism for biochemical analyzer of claim 5, wherein the propulsive guide plate (4) is provided with vertical guide rails (14) and the push plate (1) is in sliding fit on the vertical guide rails (14).

7. The sample feeding propulsion mechanism for biochemical analyzer of claim 6, wherein the vertical guide rails (14) are secured on the propulsive guide plate (4) through a mounting plate 15); the push plate (1) is connected with a fixing plate (16) on which a first slider (17) is fixed; the first slider (17) is in sliding fit on the vertical guide rails (14); a tension spring (18) is arranged between the mounting plate (15) and the fixing plate (16); the upper and lower ends of the tension spring (18) are respectively connected with the mounting plate (15) and the fixing plate (16).

8. The sample feeding propulsion mechanism for biochemical analyzer of claim 7, wherein one side of the fixing plate (16) is also provided with a support (19); the guide roller (11) is connected on the support (19) and the lower end of the tension spring (18) is connected to the support (19).

9. The sample feeding propulsion mechanism for biochemical analyzer of claim 4, wherein one end at the upper side of the base plate (7) is provided with a transmission-type optical interrupter (20), and on the transmission-type optical interrupter (20) is provided with an interrupt slot (20.1), the push plate (1) has a baffle (21), and the baffle (21) is used for penetrating through the interrupt slot (20.1) to block light rays in the interrupt slot (20.1).
